(19) United States
(12) Patent Application Publication
(10) Pub. No.: US 2006/0146999 A1
(43) Pub. Date: Jul. 6, 2006

(54) Caching engine in a messaging system

(75) Inventors: J. Barry Thompson, New York, NY (US); Kul Singh, New York, NY (US); Pierre Fraval, New York, NY (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(73) Assignee: Tervela, Inc., New York, NY (US)

(21) Appl. No.: 11/318,151

(22) Filed: Dec. 23, 2005

Related U.S. Application Data
(60) Provisional application No. 60/641,988, filed on Jan. 6, 2005.
(60) Provisional application No. 60/688,983, filed on Jun. 8, 2005.

(51) Int. Cl. H04M 11/00

(52) U.S. Cl. 379/88.18

(57) ABSTRACT

Message publish/subscribe systems are required to process high message volumes with reduced latency and performance bottlenecks. The end-to-end middleware architecture proposed by the present invention is designed for high-volume, low-latency messaging and with guaranteed delivery quality of service through data caching that uses a caching engine (CE) with storage and storage services. In a messaging, a messaging appliance (MA) receives and routes messages, but it first records all or a subset of the routed messages by sending a copy to the CE. Then, for a predetermined period of time, recorded messages are available for retransmission upon request by any component in the messaging system, thereby providing guaranteed-connected and guaranteed-disconnected delivery quality of service as well as partial data publication service.

### REFERENCE TO EARLIER-FILED APPLICATIONS

This application claims the benefit and incorporates by reference U.S. Provisional Application Ser. No. 60/641,988, filed Jan. 6, 2005, entitled “Event Router System and Method” and U.S. Provisional Application Ser. No. 60/688,983, filed Jun. 8, 2005, entitled “Hybrid Feed Handlers And Latency Measurement.”

This application is related to and incorporates by reference U.S. patent application Ser. No. ______ (Attorney Docket No. 50003-00004), Filed Dec. 23, 2005, entitled “End-To-End Publish/Subscribe Middleware Architecture.”

### FIELD OF THE INVENTION

The present invention relates to data messaging and more particularly to a caching engine in messaging systems with a publish and subscribe (hereafter “publish/subscribe”) middleware architecture.

### BACKGROUND

The increasing level of performance required by data messaging infrastructures provides a compelling rationale for advances in networking infrastructure and protocols. Fundamentally, data distribution involves various sources and destinations of data, as well as various types of interconnect architectures and modes of communications between the data sources and destinations. Examples of existing data messaging architectures include hub-and-spoke, peer-to-peer and store-and-forward.

With the hub-and-spoke system configuration, all communications are transported through the hub, often creating performance bottlenecks when processing high volumes. Therefore, this messaging system architecture produces latency. One way to work around this bottleneck is to deploy more servers and distribute the network load across these different servers. However, such architecture presents scalability and operational problems. By comparison to a system with the hub-and-spoke configuration, a system with a peer-to-peer configuration creates unnecessary stress on the applications to process and filter data and is only as fast as its slowest consumer or node. Then, with a store-and-forward system configuration, in order to provide persistence, the system stores the data before forwarding it to the next node in the path. The storage operation is usually done by indexing and writing the messages to disk, which potentially creates performance bottlenecks. Furthermore, when message volumes increase, the indexing and writing tasks can be even slower and thus, can introduces additional latency.

In order to provide data consistency, these store-and-forward systems must provide the ability to recover from any disasters, logical or physical, with no data loss. This is usually implemented with remote disk mirroring or database replication technologies. The challenge for such implementation is to ensure data consistency between the primary and secondary sites at all times with low latency. One option is to implement a synchronous solution, where each block of data written at the primary site is considered complete after it is mirrored at the secondary site. The problem with such synchronous implementation is that it impacts the overall performance of the messaging layer. An alternative option is to implement an asynchronous approach. However, with this approach the challenge of avoiding data loss or corruption is to maintain data consistency while the disaster is occurring. Another challenge is to ensure ordering of data updates.

Existing data messaging architectures share a number of deficiencies. One common deficiency is that data messaging in existing architectures relies on software that resides at the application level. This implies that the messaging infrastructure experiences OS (operating system) queuing and network I/O (input/output), which potentially create performance bottlenecks. Another common deficiency is that existing architectures use data transport protocols statically rather than dynamically even if other protocols might be more suitable under the circumstances. A few examples of common protocols include routable multicast, broadcast or unicast. Indeed, the application programming interface (API) in existing architectures is not designed to switch between transport protocols in real time.

Also, network configuration decisions are usually made at deployment time and are usually defined to optimize one set of network and messaging conditions under specific assumptions. The limitations associated with static (fixed) configuration preclude real time dynamic network reconfiguration. In other words, existing architectures are configured for a specific transport protocol which is not always suitable for all network data transport load conditions and therefore existing architectures are often incapable of dealing, in real-time, with changes or increased load capacity requirements.

Furthermore, when data messaging is targeted for particular recipients or groups of recipients, existing messaging architectures use routable multicast for transporting data across networks. However, in a system set up for multicast there is a limitation on the number of multicast groups that can be used to distribute the data and, as a result, the messaging system ends up sending data to destinations which are not subscribed to it (i.e., consumers which are not subscribers). This increases consumers' data processing load and discard rate due to data filtering. Then, consumers that become overloaded for any reason and cannot keep up with the flow of data eventually drop incoming data and later ask for retransmissions. Retransmissions affect the entire system in that all consumers receive the repeat transmissions and all of them re-process the incoming data. Therefore, retransmissions can cause multicast storms and eventually bring the entire networked system down.

When the system is set up for unicast messaging as a way to reduce the discard rate, the messaging system may experience bandwidth saturation because of data duplication. For instance, if more than one consumer subscribes to a given topic of interest, the messaging system has to deliver the data to each subscriber, and in fact it sends a different copy of this data to each subscriber. And, although this solves the problem of consumers filtering out non-subscribed data, unicast transmission is non-scalable and thus not adaptable to substantially large groups of consumers subscribing to a particular data or to a significant overlap in consumption patterns.

One more common deficiency of existing architectures is their slow and often high number of protocol transformations. The reason for this is the IT (information technology) band-aid strategy in the Enterprise Application Integration (EIA) domain, where more and more new technologies are integrated with legacy systems.

Hence, there is a need to improve data messaging systems performance in a number of areas. Examples where performance might need improvement are speed, resource allocation, latency, and the like.

### SUMMARY OF THE INVENTION

The present invention is based, in part, on the foregoing observations and on the idea that such deficiencies can be addressed with better results using a different approach. These observations gave rise to the end-to-end message publish/subscribe architecture for high-volume and low-latency messaging and with guaranteed delivery quality of service through data caching. For this purpose, a messaging infrastructure having such architecture (a publish/subscribe middleware system) includes also a caching engine (CE) with indexing and storage services as will later described in more detail.

In general, a messaging appliance (MA) receives and routes messages. When tightly coupled with a CE, it first stores all or a subset of the routed messages by sending a copy to the CE. Then, for a predetermined period of time, recorded messages are available for retransmission upon request by any component in the messaging system, thereby providing conflated, guaranteed-while-connected and guaranteed-while-disconnected delivery quality of service as well as partial data publication service.

In order to support such services, the CE is designed to keep up with the forwarding rate of the MA. For example, the CE is designed with a high-throughput connection between the MA and the CE for pushing messages as fast as possible, a high-throughput and smart indexing mechanism for inserting and replaying messages from a back-end CE database, and high-throughput, persistent storage devices. One of the considerations in this design is reducing the latency of replay requests.

Thus, in accordance with the purpose of the present invention as shown and broadly described herein one exemplary system includes a caching engine, a messaging appliance and an interface medium. The caching engine includes a message layer operative for sending and receiving messages, a caching layer having an indexing service operative for first indexing received messages and for maintaining an image of received partially-published messages, a storage and a storage service operative for storing all or a subset of received messages in the storage, one or more physical interfaces for transporting received and transmitted messages, and a messaging transport layer with channel management for controlling transmission and reception of messages through each of the one or more physical interfaces. The physical medium between the messaging appliance and the caching engine is fabric agnostic, configured as Ethernet, memory-based direct connect or Infiniband.

Moreover, the foregoing system can be implemented with a provisioning and management system linked via the interface medium and configured for exchanging administrative messages with each messaging appliance. The caching engine configuration is communicated via administrative messages from the P&M system via the MA which is directly connected to the caching engine. Effectively the caching engine acts as another neighbor in the neighbor-based messaging architecture.

Various methods using a caching engine as described above are capable of providing quality of service in messaging. One such method is conducted in a caching engine having a messaging transport layer, an administrative message layer and a caching layer with an indexing and storage services and an associated storage. This method includes the steps of receiving data and administrative messages by the message transport layer and forwarding the administrative messages to the administrative message layer and the data messages to the caching layer, wherein message retrieve request messages forwarded to the administrative message layer are routed to the caching layer. This method further includes the steps of indexing the data messages in the indexing service, the indexing being topic-based, and storing the data messages in a storage device based on the indexing, wherein the data messages are maintained in the storage device for a predetermined period of time during which they are available for retransmission in response to message retrieve request messages.

Because the data messages are either complete data messages or partially-published data messages and each data message has an associated topic, the indexing service maintains a master image of each complete data message. Then, for a received data message that is a partially complete message, the indexing service compares the received data message against a most recent master image of a complete message with an associated topic similar to that of the partially-published message to determine how the master image should be updated. A partially-published message and a master image are both indexed and available for retransmission.

These caching engines can be configured and deployed as fault tolerant pairs, composed of a primary and secondary CEs, or as fault tolerant groups, composed of more than two CE nodes. If two or more CEs are logically linked to each other, they subscribe to the same data and thus maintain a unique and consistent view of the subscribed data. Note that subscription of CEs to data is topic-based, much like application programming interfaces (APIs). In the event of data loss, a CE can request a replay of the lost data to the other CE members of the fault-tolerant group. The synchronization of the data between CEs of the same fault-tolerant group is parallelized by the messaging fabric which, via the MAs, intelligently and efficiently forwards copies of the subscribed messaging traffic to all caching engine instances. As a result, this enables asynchronous data consistency for fault tolerant and disaster recovery deployments, where the data synchronization is performed and persistency is assured by the messaging fabric rather than by leveraging storage/disk mirroring or database replication technologies.

In sum, these and other features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates an end-to-end middleware architecture in accordance with the principles of the present invention.

FIG. 1a is a diagram illustrating an overlay network.

FIG. 2 is a diagram illustrating an enterprise infrastructure implemented with an end-to-end middleware architecture according to the principles of the present invention.

FIG. 3 illustrates a channel-based messaging system architecture.

FIG. 4 illustrates one possible topic-based message format.

FIG. 5 shows a topic-based message routing and routing table.

FIG. 6 shows the interface for communications between the MA and the CE.

FIG. 7 is a block diagram illustrating a CE (caching engine) configured in accordance with one embodiment of the invention.

FIG. 8 shows a fault-tolerant configuration with a primary and secondary caching engine, and illustrates the different phases in the event of a failure.

### DETAILED DESCRIPTION

Before outlining the details of various embodiments in accordance with aspects and principles of the present invention the following is a brief explanation of some terms that may be used throughout this description. It is noted that this explanation is intended to merely clarify and give the reader an understanding of how such terms might be used, but without limiting these terms to the context in which they are used and without limiting the scope of the claims thereby.

The term “middleware” is used in the computer industry as a general term for any programming that mediates between two separate and often already existing programs. Typically, middleware programs provide messaging services so that different applications can communicate. The systematic tying together of disparate applications, often through the use of middleware, is known as enterprise application integration (EAI). In this context, however, “middleware” can be a broader term used in the context of messaging between source and destination and the facilities deployed to enable such messaging; and, thus, middleware architecture covers the networking and computer hardware and software components that facilitate effective data messaging, individually and in combination as will be described below. Moreover, the terms “messaging system” or “middleware system,” can be used in the context of publish/subscribe systems in which messaging servers manage the routing of messages between publishers and subscribers. Indeed, the paradigm of publish/subscribe in messaging middleware is a scalable and thus powerful model.

The term “consumer” may be used in the context of client-server applications and the like. In one instance a consumer is a system or an application that uses an application programming interface (API) to register to a middleware system, to subscribe to information, and to receive data delivered by the middleware system. An API inside the middleware architecture boundaries is a consumer; and an external consumer is any publish/subscribe system (or external data destination) that doesn't use the API and for communications with which messages go through protocol transformation (as will be later explained).

The term “external data source” may be used in the context of data distribution and message publish/subscribe systems. In one instance, an external data source is regarded as a system or application, located within or outside the enterprise private network, which publishes messages in one of the common protocols or its own message protocol. An example of an external data source is a market data exchange that publishes stock market quotes which are distributed to traders via the middleware system. Another example of an external data source is transactional data. Note that in a typical implementation of the present invention, as will be later described in more detail, the middleware architecture adopts its unique native protocol to which data from external data sources is converted once it enters the middleware system domain, thereby avoiding multiple protocol transformations typical of conventional systems.

The term “external data destination” is also used in the context of data distribution and message publish/subscribe systems. An external data destination is, for instance, a system or application, located within or outside the enterprise private network, which is subscribing to information routed via a local/global network. One example of an external data destination could be the aforementioned market data exchange that handles transaction orders published by the traders. Another example of an external data destination is transactional data. Note that, in the foregoing middleware architecture messages directed to an external data destination are translated from the native protocol to the external protocol associated with the external data destination.

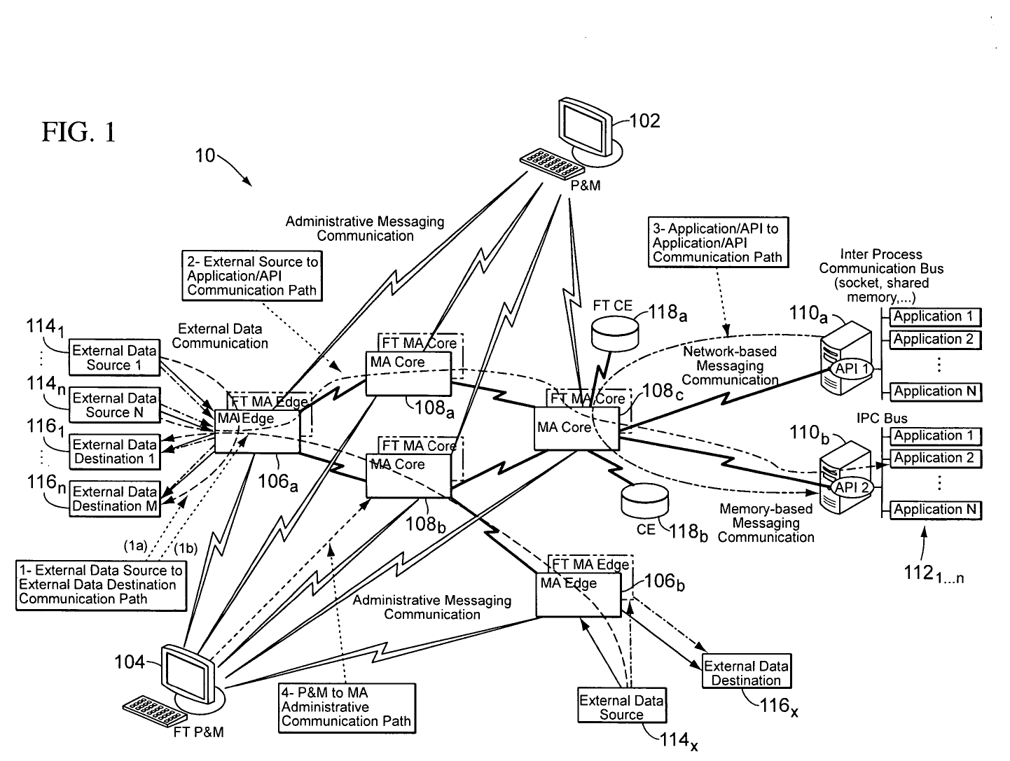

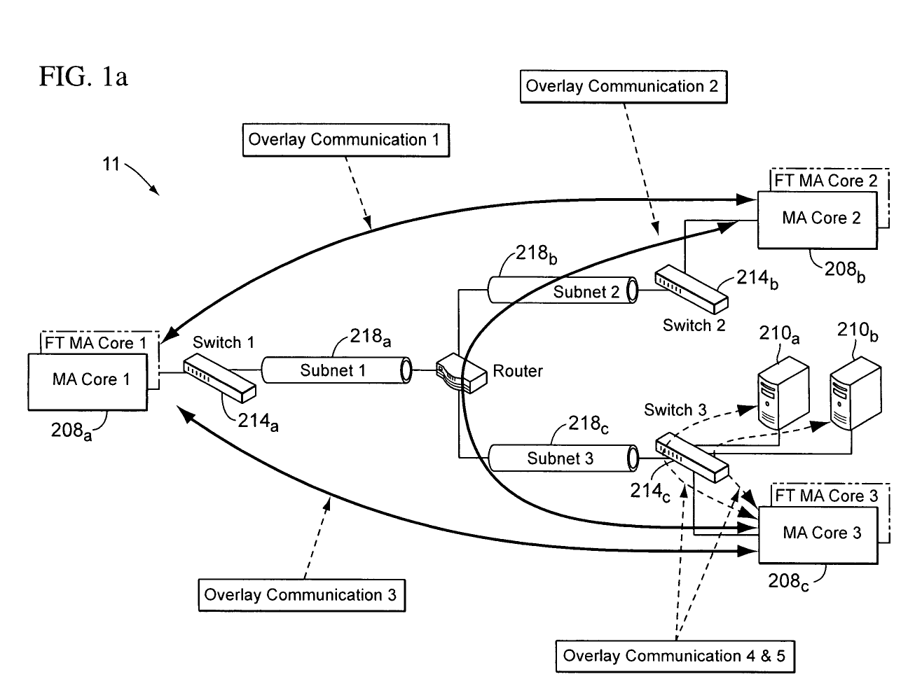

As can be ascertained from the description herein, the present invention can be practiced in various ways with the caching engine (CE) being implemented in various configurations within a middleware architecture. The description therefore starts with an example of an end-to-end middleware architecture as shown in FIG. 1.

This exemplary architecture combines a number of beneficial features which include: messaging common concepts, APIs, fault tolerance, provisioning and management (P&M), quality of service (QoS—conflated, best-effort, guaranteed-while-connected, guaranteed-while-disconnected etc.), persistent caching for guaranteed delivery QoS, management of namespace and security service, a publish/subscribe ecosystem (core, ingress and egress components), transport-transparent messaging, neighbor-based messaging (a model that is a hybrid between hub-and-spoke, peer-to-peer, and store-and-forward, and which uses a subscription-based routing protocol that can propagate the subscriptions to all neighbors as necessary), late schema binding, partial publishing (publishing changed information only as opposed to the entire data) and dynamic allocation of network and system resources. As will be later explained, the publish/subscribe system advantageously incorporates a fault tolerant design of the middleware architecture. Note that the core MAs portion of the publish/subscribe ecosystem uses the aforementioned native messaging protocol (native to the middleware system) while the ingress and egress portions, the edge MAs, translate to and from this native protocol, respectively.

In addition to the publish/subscribe system components, the diagram of FIG. 1 shows the logical connections and communications between them. As can be seen, the illustrated middleware architecture is that of a distributed system. In a system with this architecture, a logical communication between two distinct physical components is established with a message stream and associated message protocol. The message stream contains one of two categories of messages: administrative and data messages. The administrative messages are used for management and control of the different physical components, management of subscriptions to data, and more. The data messages are used for transporting data between sources and destinations, and in a typical publish/subscribe messaging there are multiple senders and multiple receivers of data messages.

With the structural configuration and logical communications as illustrated the distributed publish/subscribe system with the middleware architecture is designed to perform a number of logical functions. One logical function is message protocol translation which is advantageously performed at an edge messaging appliance (MA) component. A second logical function is routing the messages from publishers to subscribers. Note that the messages are routed throughout the publish/subscribe network. Thus, the routing function is performed by each MA where messages are propagated, say, from an edge MA 106a-b (or API) to a core MA 108a-c or from one core MA to another core MA and eventually to an edge MA (e.g., 106b) or API 110a-b. The API 110a-b communicates with applications 112₁-n via an inter-process communication bus (sockets, shared memory etc.).

A third logical function is storing messages for different types of guaranteed-delivery quality of service, including for instance guaranteed-while-connected and guaranteed-while-disconnected. A fourth function is delivering these messages to the subscribers. As shown, an API 106a-b delivers messages to subscribing applications 112₁-n.

In this publish/subscribe middleware architecture, the system configuration function as well as other administrative and system performance monitoring functions, are managed by the P&M system 102, 104. Configuration involves both physical and logical configuration of the publish/subscribe middleware system network and components. The monitoring and reporting involves monitoring the health of all network and system components and reporting the results automatically, per demand or to a log. The P&M system performs its configuration, monitoring and reporting functions via administrative messages. In addition, the P&M system allows the system administrator to define a message namespace associated with each of the messages routed throughout the publish/subscribe network. Accordingly, a publish/subscribe network can be physically and/or logically divided into namespace-based sub-networks.

The P&M system manages a publish/subscribe middleware system with one or more MAs. These MAs are deployed as edge MAs or core MAs, depending on their role in the network. An edge MA is similar to a core MA in most respects, except that it includes a protocol translation engine that transforms messages from external to native protocols and from native to external protocols. Thus, in general, the boundaries of the publish/subscribe system middleware architecture are characterized by its edges at which there are edge MAs 106a-b and APIs 110a-b; and within these boundaries there are core MAs 108a-c.

Note that the system architecture is not confined to a particular limited geographic area and, in fact, is designed to transcend regional or national boundaries and even span across continents. In such cases, the edge MAs in one network can communicate with the edge MAs in another geographically distant network via existing networking infrastructures.

In a typical system, the core MAs 108a-c route the published messages internally within the system towards the edge MAs or APIs (e.g., APIs 110a-b). The routing map, particularly in the core MAs, is designed for maximum volume, low latency, and efficient routing. Moreover, the routing between the core MAs can change dynamically in real-time. For a given messaging path that traverses a number of nodes (core MAs), a real time change of routing is based on one or more metrics, including network utilization, overall end-to-end latency, communications volume, network delay, loss and jitter.

Alternatively, instead of dynamically selecting the best performing path out of two or more diverse paths, the MA can perform multi-path routing based on message replication and thus send the same message across all paths. All the MAs located at convergence points of diverse paths will drop the duplicated messages and forward only the first arrived message. This routing approach has the advantage of optimizing the messaging infrastructure for low latency; although the drawback of this routing method is that the infrastructure requires more network bandwidth to carry the duplicated traffic.

The edge MAs have the ability to convert any external message protocol of incoming messages to the middleware system's native message protocol; and from native to external protocol for outgoing messages. That is, an external protocol is converted to the native (e.g., Tervela™) message protocol when messages are entering the publish/subscribe network domain (ingress); and the native protocol is converted into the external protocol when messages exit the publish/subscribe network domain (egress). Another function of edge MAs is to deliver the published messages to the subscribing external data destinations.

Additionally, both the edge and the core MAs 106a-b and 108a-c are capable of storing the messages before forwarding them. One way this can be done is with a caching engine (CE) 118a-b. One or more CEs can be connected to the same MA. Theoretically, the API is said not to have this store-and-forward capability although in reality an API 110a-b could store messages before delivering them to the application, and it can store messages received from applications before delivering them to a core MA, edge MA or another API.

When an MA (edge or core MA) has an active connection to a CE, it forwards all or a subset of the routed messages to the CE which writes them to a storage area for persistency. For a predetermined period of time, recorded messages are available for retransmission upon request. Examples that leverage this architecture are data replay, partial publish and various quality of service levels. Partial publish is effective in reducing network and consumers load because it requires transmission only of updated information rather than of all information.

To illustrate how the routing maps might effect routing, a few examples of the publish/subscribe routing paths are shown in FIG. 1. In this illustration, the middleware architecture of the publish/subscribe network provides five or more different communication paths between publishers and subscribers.

The first communication path links an external data source to an external data destination. The published messages received from the external data source 114₁-n are translated into the native (e.g., Tervela™) message protocol and then routed by the edge MA 106a. One way the native protocol messages can be routed from the edge MA 106a is to an external data destination 116n. This path is called out as communication path 1a. In this case, the native protocol messages are converted into the external protocol messages suitable for the external data destination. Another way the native protocol messages can be routed from the edge MA 106b is internally through a core MA 108b. This path is called out as communication path 1b. Along this path, the core MA 108b routes the native messages to an edge MA 106a. However, before the edge MA 106a routes the native protocol messages to the external data destination 116₁, it converts them into an external message protocol suitable for this external data destination 116₁. As can be seen, this communication path doesn't require the API to route the messages from the publishers to the subscribers. Therefore, if the publish/subscribe system is used for external source-to-destination communications, the system need not include an API.

Another communication path, called out as communications path 2, links an external data source 114n to an application using the API 110b. Published messages received from the external data source are translated at the edge MA 106a into the native message protocol and are then routed by the edge MA to a core MA 108a. From the first core MA 108a, the messages are routed through another core MA 108c to the API 110b. From the API the messages are delivered to subscribing applications (e.g., 112₂). Because the communication paths are bidirectional, in another instance, messages could follow a reverse path from the subscribing applications 112₁₋ₙ to the external data destination 116n. In each instance, core MAs receive and route native protocol messages while edge MAs receive external or native protocol messages and, respectively, route native or external protocol messages (edge MAs translate to/from such external message protocol to/from the native message protocol). Each of the edge MAs can route an ingress message simultaneously to both native protocol channels and external protocol channels. As a result, each edge MA can route an ingress message simultaneously to both external and internal consumers, where internal consumers consume native protocol messages and external consumers consume external protocol messages. This capability enables the messaging infrastructure to seamlessly and smoothly integrate with legacy applications and systems.

Yet another communication path, called out as communications path 3, links two applications, both using an API 110a-b. At least one of the applications publishes messages or subscribes to messages. The delivery of published messages to (or from) subscribing (or publishing) applications is done via an API that sits on the edge of the publish/subscribe network. When applications subscribe to messages, one of the core or edge MAs routes the messages towards the API which, in turn, notifies the subscribing applications when the data is ready to be delivered to them. Messages published from an application are sent via the API to the core MA 108c to which the API is ‘registered’.

Note that by ‘registering’ (logging in) to an MA, the API becomes logically connected to it. An API initiates the connection to the MA by sending a registration (‘log-in’ request) message to the MA. After registration, the API can subscribe to particular topics of interest by sending its subscription messages to the MA. Topics are used for publish/subscribe messaging to define shared access domains and the targets for a message, and therefore a subscription to one or more topics permits reception and transmission of messages with such topic notations. The P&M sends to the MAs in the network periodic entitlement updates and each MA updates its own table accordingly. Hence, if the MA find the API to be entitled to subscribe to a particular topic (the MA verifies the API's entitlements using the routing entitlements table) the MA activates the logical connection to the API. Then, if the API is properly registered with it, the core MA 108c routes the data to the second API 110 as shown. In other instances this core MA 108b may route the messages through additional one or more core MAs (not shown) which route the messages to the API 110b that, in turn, delivers the messages to subscribing applications 112₁-n.

As can be seen, communications path 3 doesn't require the presence of an edge MA, because it doesn't involve any external data message protocol. In one embodiment exemplifying this kind of communications path, an enterprise system is configured with a news server that publishes to employees the latest news on various topics. To receive the news, employees subscribe to their topics of interest via a news browser application using the API.

Note that the middleware architecture allows subscription to one or more topics. Moreover, this architecture allows subscription to a group of related topics with a single subscription request, by allowing wildcards in topic notation.

Yet another path, called out as communications path 4, is one of the many paths associated with the P&M system 102 and 104 with each of them linking the P&M to one of the MAs in the publish/subscribe network middleware architecture. The messages going back and forth between the P&M system and each MA are administrative messages used to configure and monitor that MA. In one system configuration, the P&M system communicates directly with the MAs. In another system configuration, the P&M system communicates with MAs through other MAs. In yet another configuration the P&M system can communicate with the MAs both directly or indirectly.

In a typical implementation, the middleware architecture can be deployed over a network with switches, routers and other networking appliances, and it employs channel-based messaging capable of communications over any type of physical medium. One exemplary implementation of this fabric-agnostic channel-based messaging is an IP-based network. In this environment, all communications between all the publish/subscribe physical components are performed over UDP (User Datagram Protocol), and the transport reliability is provided by the messaging layer. An overlay network according to this principle is illustrated in FIG. 1a.

As shown, overlay communications 1, 2 and 3 can occur between the three core MAs 208a-c via switches 214a-c, a router 216 and subnets 218a-c. In other words, these communication paths can be established on top of the underlying network which is composed of networking infrastructure such as subnets, switches and routers, and, as mentioned, this architecture can span over a large geographic area (different countries and even different continents).

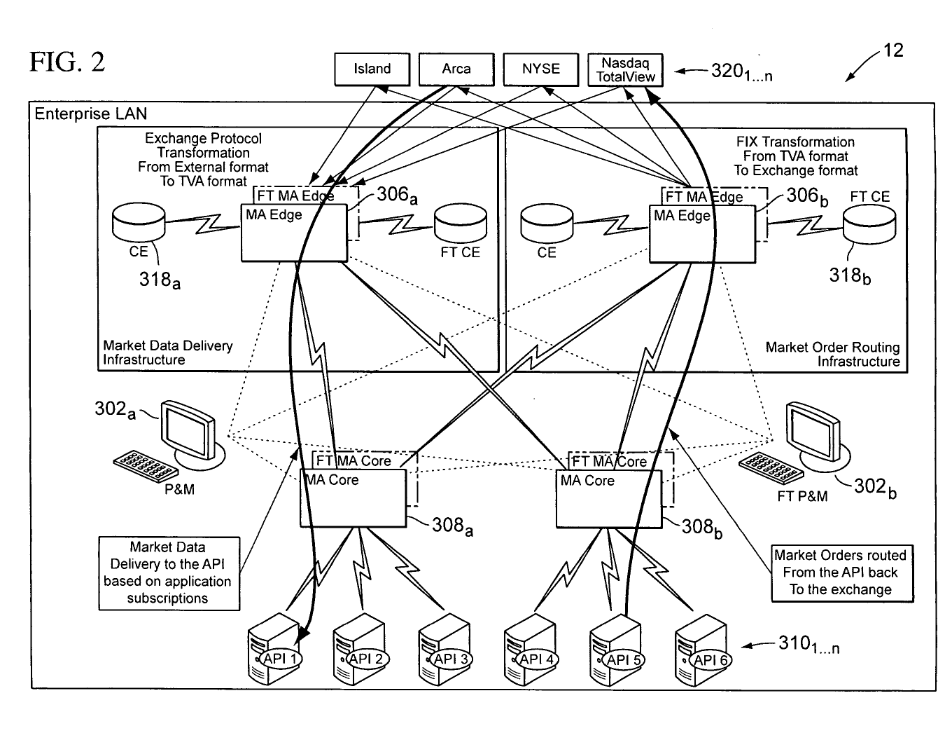

Notably, the foregoing and other end-to-end middleware architectures according to the principles of the present invention can be implemented in various enterprise infrastructures in various business environments. One such implementation is illustrated on FIG. 2.

In this enterprise infrastructure, a market data distribution plant 12 is built on top of the publish/subscribe network for routing stock market quotes from the various market data exchanges 320₁-n to the traders (applications not shown). Such an overlay solution relies on the underlying network for providing interconnects, for instance, between the MAs as well as between such MAs and the P&M system. Market data delivery to the APIs 310₁-n is based on applications subscription. With this infrastructure, traders using the applications (not shown) can place transaction orders that are routed from the APIs 310₁-n through the publish/subscribe network (via core MAs 308a-b and the edge MA 306b) back to the market data exchanges 320₁-n.

Logically, the physical components of the publish/subscribe network are built on a messaging transport layer akin to layers 1 to 4 of the Open Systems Interconnection (OSI) reference model. Layers 1 to 4 of the OSI model are respectively the Physical, Data Link, Network and Transport layers.

Thus, in one embodiment of the invention, the publish/subscribe network can be directly deployed into the underlying network/fabric by, for instance, inserting one or more messaging line card in all or a subset of the network switches and routers. In another embodiment of the invention, the publish/subscribe network can be deployed as a mesh overlay network (in which all the physical components are connected to each other). For instance, a fully-meshed network of 4 MAs is a network in which each of the MAs is connected to each of its 3 peer MAs. In a typical implementation, the publish/subscribe network is a mesh network of one or more external data sources and/or destinations, one or more provisioning and management (P&M) systems, one or more messaging appliances (MAs), one or more optional caching engines (CE) and one or more optional application programming interfaces (APIs).

Notably, communications throughout the publish/subscribe network are conducted using the native protocol messages independently from the underlying transport logic. This is why we refer to this architecture as a transport-transparent channel-based messaging architecture.

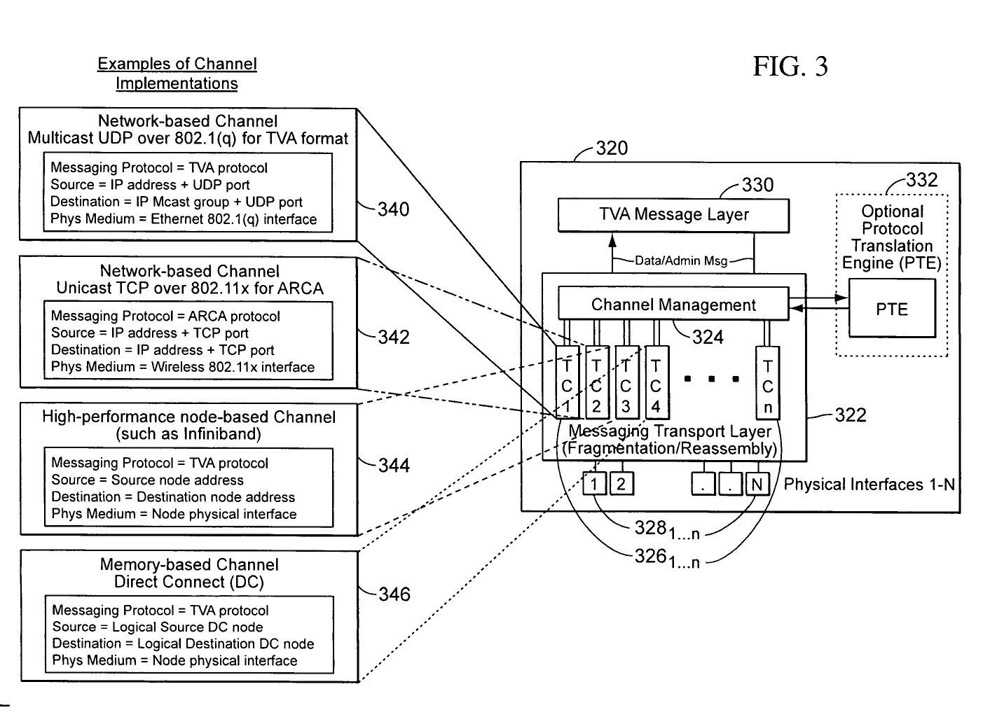

FIG. 3 illustrate in more details the channel-based messaging architecture 320. Generally, each communication path between the messaging source and destination is considered a messaging transport channel. Each channel 326₁-n, is established over a physical medium with interfaces 328₁-n between the channel source and the channel destination. Each such channel is established for a specific message protocol, such as the native (e.g., Tervela™) message protocol or others. Only edge MAs (those that manage the ingress and egress of the publish/subscribe network) use the channel message protocol (external message protocol). Based on the channel message protocol, the channel management layer 324 determines whether incoming and outgoing messages require protocol translation. In each edge MA, if the channel message protocol of incoming messages is different from the native protocol, the channel management layer 324 will perform a protocol translation by sending the message for process through the protocol translation engine (PTE) 332 before passing them along to the native message layer 330. Also, in each edge MA, if the native message protocol of outgoing messages is different from the channel message protocol (external message protocol), the channel management layer 324 will perform a protocol translation by sending the message for process through the protocol translation engine (PTE) 332 before routing them to the transport channel 326₁-n. Hence, the channel manages the interface 328₁-n with the physical medium as well as the specific network and transport logic associated with that physical medium and the message reassembly or fragmentation.

In other words, a channel manages the OSI transport to physical layers 322. Optimization of channel resources is done on a per channel basis (e.g., message density optimization for the physical medium based on consumption patterns, including bandwidth, message size distribution, channel destination resources and channel health statistics). Then, because the communication channels are fabric agnostic, no particular type of fabric is required. Indeed, any fabric medium will do, e.g., ATM, Infiniband or Ethernet.

Incidentally, message fragmentation or re-assembly may be needed when, for instance, a single message is split across multiple frames or multiple messages are packed in a single frame Message fragmentation or reassembly is done before delivering messages to the channel management layer.

FIG. 3 further illustrates a number of possible channels implementations in a network with the middleware architecture. In one implementation 340, the communication is done via a network-based channel using multicast over an Ethernet switched network which serves as the physical medium for such communications. In this implementation the source send messages from its IP address, via its UDP port, to the group of destinations (defined as an IP multicast address) with its associated UDP port. In a variation of this implementation 342, the communication between the source and destination is done over an Ethernet switched network using UDP unicast. From its IP address, the source sends messages, via a UDP port, to a select destination with a UDP port at its respective IP address.

In another implementation 344, the channel is established over an Infiniband interconnect using a native Infiniband transport protocol, where the Infiniband fabric is the physical medium. In this implementation the channel is node-based and communications between the source and destination are node-based using their respective node addresses. In yet another implementation 346, the channel is memory-based, such as RDMA (Remote Direct Memory Access), and referred to here as direct connect (DC). With this type of channel, messages are sent from a source machine directly into the destination machine's memory, thus, bypassing the CPU processing to handle the message from the NIC to the application memory space, and potentially bypassing the network overhead of encapsulating messages into network packets.

As to the native protocol, one approach uses the aforementioned native Tervela™ message protocol. Conceptually, the Tervela™ message protocol is similar to an IP-based protocol. Each message contains a message header and a message payload. The message header contains a number of fields one of which is for the topic information. As mentioned, a topic is used by consumers to subscribe to a shared domain of information.

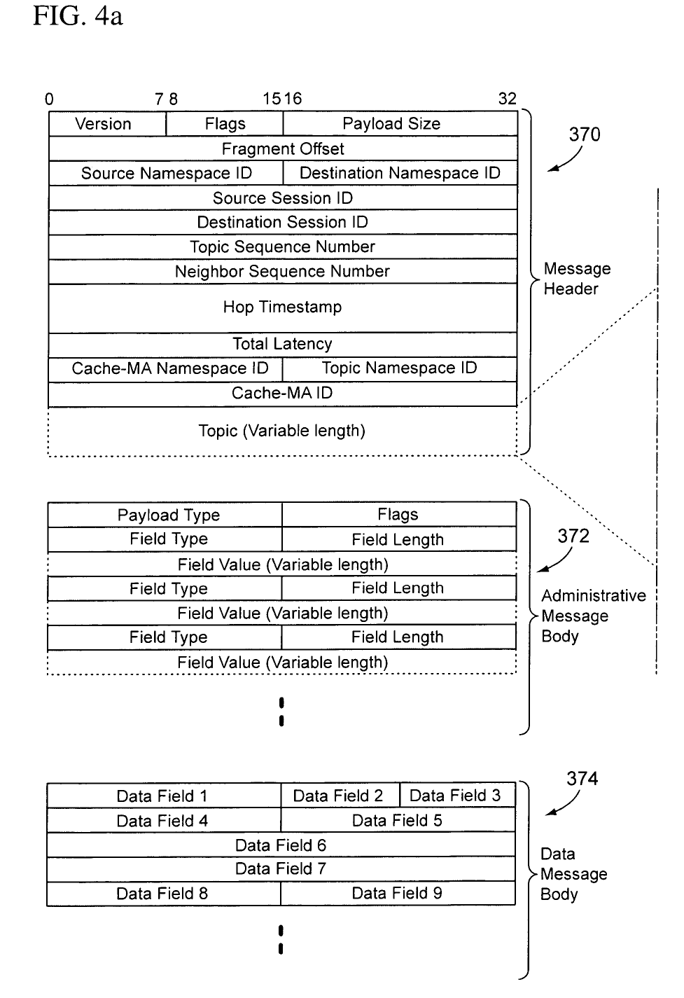

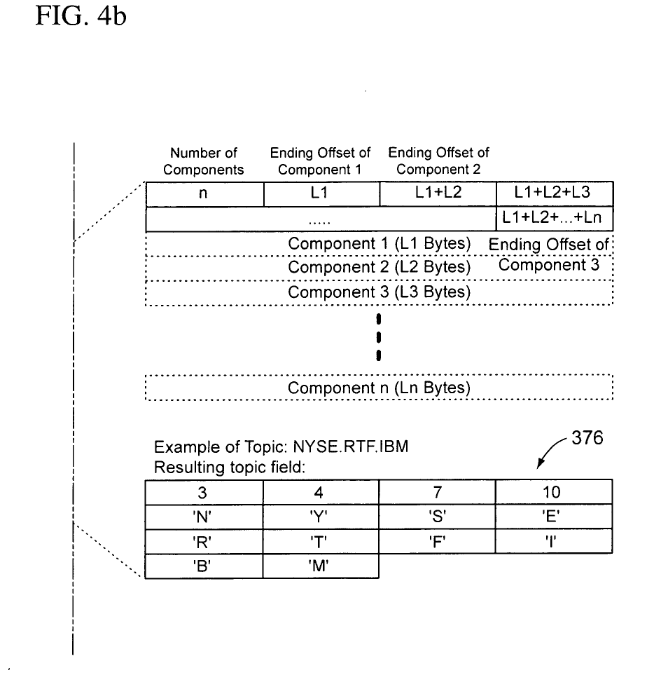

FIG. 4 illustrates one possible topic-based message format. As shown, messages include a header 370 and a body 372 and 374 which includes the payload. The two types of messages, data and administrative are shown with different message bodies and payload types. The header includes fields for the source and destination namespace identifications, source and destination session identifications, topic sequence number and hope timestamp, and, in addition, it includes the topic notation field (which is preferably of variable length).

A topic might be defined as a token-based string, such as T1.T2.T3.T4, where T1, T2, T3 and T4 are strings of variable lengths. In one example, the topic might be defined as NYSE.RTF.IBM 376 which is the topic notation for messages containing the real time quote of the IBM stock. In some instances, the topic notation in the message might be encoded or mapped to a key, which can be one or more integer values. In such cases, each topic would be mapped to a unique key, and the database which maps between topics and keys would be maintained by the P&M system and updated over the wire to all MAs. As a result, when an API subscribes or publishes to one topic, the MA is able to return the associated unique key that is used for the topic field of the message.

Preferably, the subscription format will follow the same format as the message topic. However, the subscription format also supports wildcards that match any topic substring or regular expression pattern-matching against the topic string. Handling of wildcard mapping to actual topics may be dependant on the P&M system or handled by the MA depending on the complexity of the wildcard or pattern-matching request.

For instance, pattern matching follows matching rules such as:

Example #1: A string with a wildcard of T1.*.T3.T4 would match T1.T2a.T3.T4 and T1.T2b.T3.T4 but would not match T1.T2.T3.T4.T5

Example #2: A string with wildcards of T1.*.T3.T4.* would not match T1.T2a.T3.T4 and T1.T2b.T3.T4 but it would match T1.T2.T3.T4.T5

Example #3: A string with wildcards of T1.*.T3.T4[*] (optional 5^{th} element) would match T1.T2a.T3.T4, T1.T2b.T3.T4 and T1.T2.T3.T4.T5 but would not match T1.T2.T3.T4.T5.T6

Example #4: A string with a wildcard of T1.T2*.T3.T4 would match T1.T2a.T3.T4 and T1.T2b.T3.T4 but would not match T1.T5a.T3.T4

Example #5: A string with wildcards of T1.*.T3.T4.> (any number of trailing elements) would match T1.T2a.T3.T4, T1.T2b.T3.T4, T1.T2.T3.T4.T5 and T1.T2.T3.T4.T5.T6.

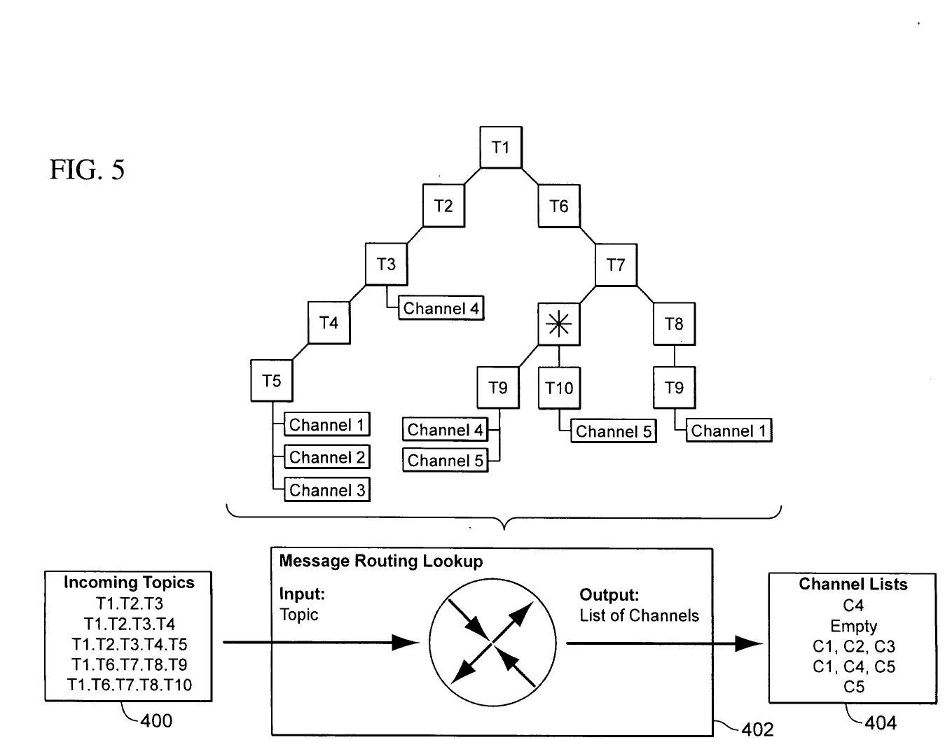

FIG. 5 shows topic-based message routing. As indicated, a topic might be defined as a token-based string, such as T1.T2.T3.T4, where T1, T2, T3 and T4 are strings of variable lengths. As can be seen, incoming messages with particular topic notations 400 are selectively routed to communications channels 404, and the routing determination is made based on a routing table 402. The mapping of the topic subscription to the channel defines the route and is used to propagate messages throughout the publish/subscribe network. The superset of all these routes, or mapping between subscriptions and channels, defines the routing table. The routing table is also referred to as the subscription table. The subscription table for routing via string-based topics can be structured in a number of ways, but is preferably configured for optimizing its size as well as the routing lookup speed. In one implementation, the subscription table may be defined as a dynamic hash map structure, and in another implementation the subscription table may be arranged in a tree structure as shown in the diagram of FIG. 5.

A tree includes nodes (e.g., T₁, . . . T₁₀) connected by edges, where each sub-string of a topic subscription corresponds to a node in the tree. The channels mapped to a given subscription are stored on the leaf node of that subscription indicating, for each leaf node, the list of channels from where the topic subscription came (i.e. through which subscription requests were received). This list indicates which channel should receive a copy of the message whose topic notation matches the subscription. As shown, the message routing lookup takes a message topic as input and parse the tree using each substring of that topic to locate the different channels associated with the incoming message topic. For instance, T₁, T₂, T₃, T₄ and T₅ are directed to channels 1, 2 and 3; T₁, T₂, and T₃, are directed to channel 4; T₁, T₆, T₇, T• and T₉ are directed to channels 4 and 5; T₁, T₆, T₇, T₈ and T₉ are directed to channel 1; and T₁, T₆, T₇, T• and T₁₀ are directed to channel 5.

Although selection of the routing table structure is intended to optimize the routing table lookup, performance of the lookup depends also on the search algorithm for finding the one or more topic subscriptions that match an incoming message topic. Therefore, the routing table structure should be able to accommodate such algorithm and vice versa. One way to reduce the size of the routing table is by allowing the routing algorithm to selectively propagate the subscriptions throughout the entire publish/subscribe network. For example, if a subscription appears to be a subset of another subscription (e.g., a portion of the entire string) that has already been propagated, there is no need to propagate the subset subscription since the MAs already have the information for the superset of this subscription.

Based on the foregoing, the preferred message routing protocol is a topic-based routing protocol, where entitlements are indicated in the mapping between subscribers and respective topics. Entitlements are designated per subscriber or groups/classes of subscribers and indicate what messages the subscriber has a right to consume, or which messages may be produced (published) by such producer (publisher). These entitlements are defined in the P&M system, communicated to all MAs in the publish/subscribe network, and then used by the MA to create and update their routing tables.

All messages that are routed in the publish/subscribe network are received or sent on a particular channel. Using these channels, the MA communicates with all other physical components in the publish/subscribe network. However, there are times when these interfaces are interrupted or destinations can't keep up with the load. In these and other similar situations, the messages may be recalled from storage and retransmitted. Hence, whenever store and forward functionality is needed the MAs can operatively associate with a caching engine (CE). Moreover, because very often, reliability, availability and consistency are necessary in enterprise operations the publish/subscribe system can be designed for fault tolerance with several of its components being deployed as fault tolerant systems.

For instance, MAs can be deployed as fault-tolerant MA pairs, where the first MA is called the primary MA, and the second MA is called the secondary MA or fault-tolerant MA (FT MA). Then, for the store and forward operations, the CE (cache engine) can be connected to a primary or secondary core/edge MA. When a primary or secondary MA has an active connection to a CE, it forwards all or a subset of the routed messages to that CE which indexes and stores them to a storage area for persistency. For a predetermined period of time, recorded messages are available for retransmission upon request. Additionally, as shown in FIG. 2, CEs can be deployed as fault tolerant CE pairs with a secondary CE taking over for a primary CE in case of a failure.

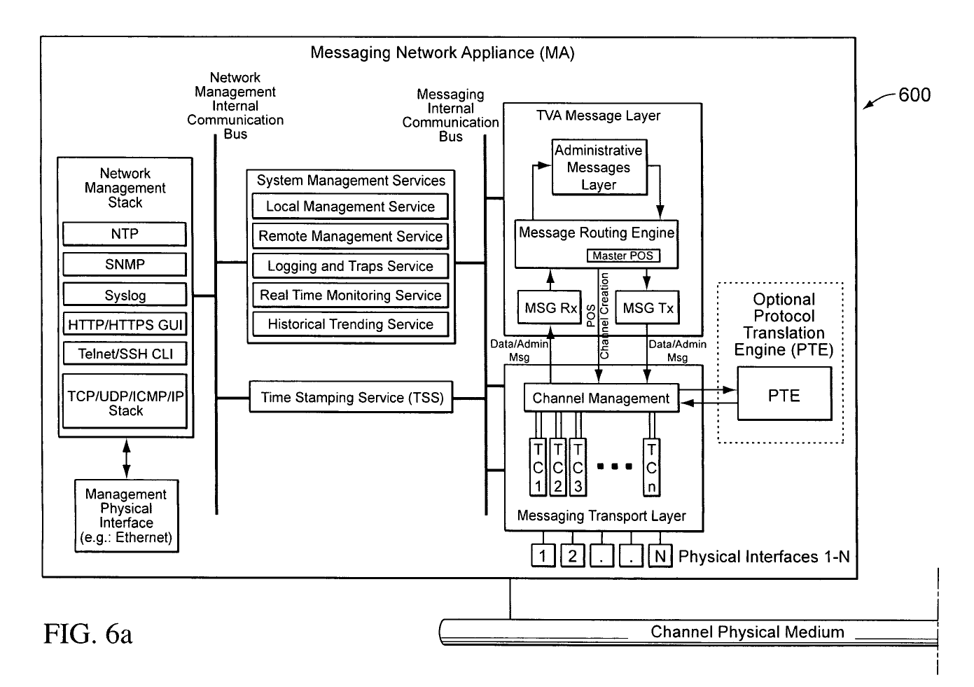

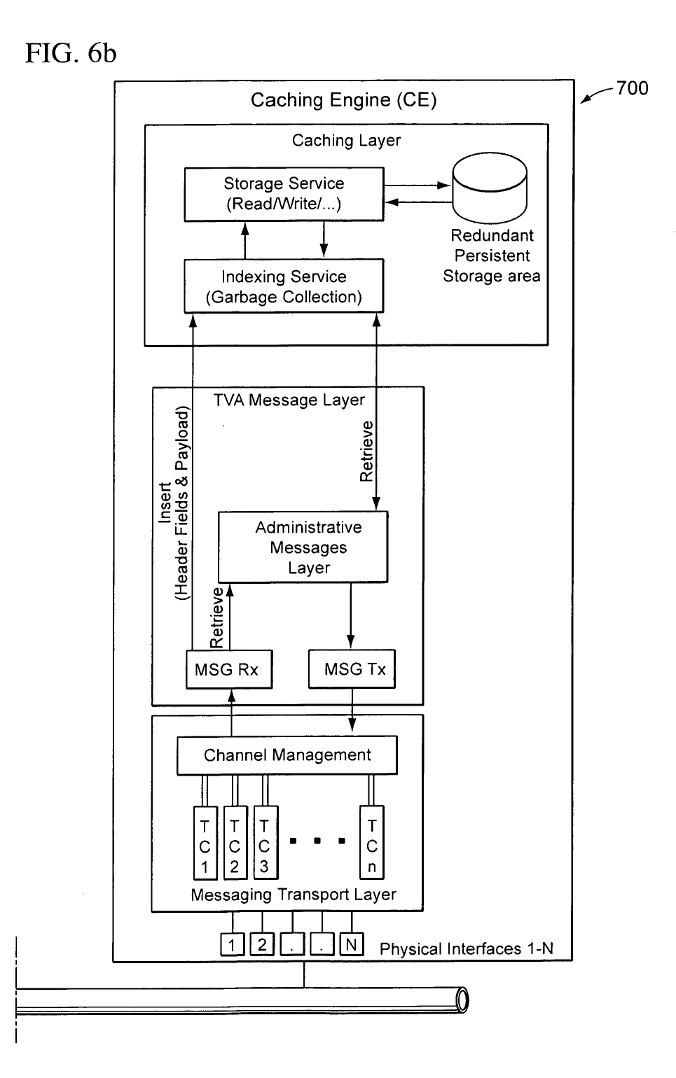

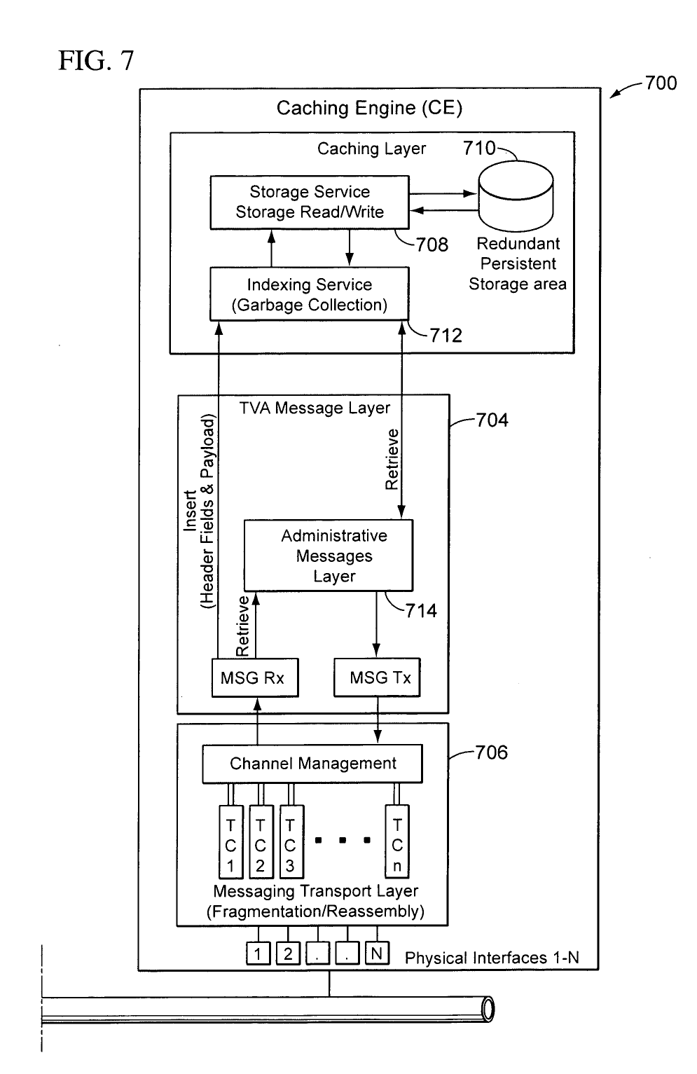

As shown in FIG. 6, the CE is connected via a physical medium directly to the MA, and it is designed to provide the feature of a store-and-forward architecture in a high-volume and low-latency messaging environment. Then, FIG. 7 is a block diagram illustrating a CE configured in accordance with one embodiment of the invention.

The CE 700 performs a number of functions. For message data persistency, one function involves receiving data messages forwarded by the MA, indexing them using different message header fields, and storing them in a storage area 710. Another function involves responding to message-retrieve requests from the MA and retransmitting messages that have been lost, or not received, (and thus requested again by consumers).

Generally, the CE is built on the same logical layers as an MA. However, its native (e.g., Tervela™) messaging layer is considerably simplified. There is no need for routing engine logic because, as opposed to being routed to another physical component in the publish/subscribe network, all the messages are handled and delivered locally at the CE to its administrative message layer 714 or to its caching layer 702. As before, the administrative messages are typically used for administrative purpose, except the retrieve requests that are forwarded to the caching layer 702. All the data messages are forwarded to the caching layer, which uses an indexing service 712 to first index the messages with topic-based indexing, and then a storage service 708 for storing the messages in the storage area 710 (e.g., RAID, disk, or the like). All data messages are held for a predefined period of time in the storage area 710 which is often a redundant persistent storage. The indexing service 712 is responsible for ‘garbage collection’ activity and notifies the storage service 708 when expired data messages need to be discarded from the storage area.

The CE can be a software-based or an embedded solution. More specifically, the CE can be configured as a software application running on top of an operating system (OS) in high-end server. Such server might include a high-performance NIC (network interface card) to increase the data transfer rates to/from an MA. In another configuration, the CE is an embedded solution for speeding both the network I/O (input/output) from and to the MA and accelerating the storage I/O from and to the storage area. Such embedded solution can be designed for efficiently streaming data to one or more disks. Thus, for generally improving performance, implementations of the CE are designed for maximizing MA-CE-storage data transfer rates and for minimizing requested messages retrieval latency.

For instance, in order to maximize the data transfers between the MA and the CE, their communication link is implemented as a direct 10 Gigabit/s Ethernet fiber interconnect or any other high-throughput and low-latency interconnect, such as Myrinet. And, in order to increase the throughput on this link, the CE could pack as many messages as possible in a single large frame. Moreover, a software-based CE communicates with the MA via remote direct memory access which bypasses the CPU (central processing unit) and the OS to thereby maximize throughput and minimize latency. Then, to maximize storage I/O efficiency, the CE distributes disk I/O across multiple storage devices. In one implementation, the CE uses a combination of distributed database logic and distributed high-performance redundant storage technologies. Also, to minimize requested messages retrieval latency, one implementation of the CE uses RAM (random access memory) to maintain the indexes and the most recent messages or the most-often-retrieved messages before flushing these messages to the storage devices.

When it interfaces with an MA, the CE handles two types of messages, one type is regular or complete data messages and the other type is incomplete or partially-published data messages. Specifically, when the indexing service 712 of the CE 700 receives a partially published message it compares that message against the last known complete message on the same topic, also described as the master image of this partially-published message. The indexing service 712 maintains a master image in RAM (not shown) for all complete messages. The partially-published messages (message updates with new values) replace the old values in the master image of the message while maintaining untouched values which are not updated thereby. Much like any other data message, the partially-published message is indexed and is available for retransmission. And, like any other message recorded by the CE, the master image is also available for retransmission, except that the master image might be provided as a different message type, or its message header flag might have a different value indicating that it is a master image. Indeed, the master image may be of interest to applications, and, using their respective API, such applications can request the master image of a partially-published message stream at any given time. Subsequently, such applications receive partially-published message updates.

To provide conflated, guaranteed-while-connected and guaranteed-while-disconnected Quality-of-Service (QoS), the messaging fabric must provide data persistency and integrity at all times. In order to provide a fault-tolerant persistent caching solution, these caching engines can be configured and deployed as fault tolerant pairs, composed of primary and secondary CE pairs, or as fault tolerant groups composed of more than two CE nodes. If two or more caching engines are logically linked to each other, via same-topic(s)-based subscription, they subscribe to the same data and thus maintain a unique and consistent view of the subscribed data. In the event of data loss, a caching engine can request a replay of the lost data to the other caching engines members of the fault-tolerant group. The synchronization of the data between caching engines of the same fault-tolerant group is parallelized by the messaging fabric which, via the MAs, intelligently and efficiently forwards copies of the subscribed messaging traffic to all caching engine instances. As a result, this enables asynchronous data consistency for fault tolerant and disaster recovery deployments, where the data synchronization and persistency is performed and assured by the messaging fabric, as opposed to leverage storage/disk mirroring or database replication technologies.

One of the benefits of using the messaging fabric for redundancy and data consistency is to reduce the bandwidth utilization due to synchronization traffic because only the data is synchronized between caching engines, as opposed to data and indexes (for database replication) and/or disk storage overhead (for remote disk mirroring). A second benefit is to resolve the message ordering, since the messaging layer already assures the order of messages on any given subscription.

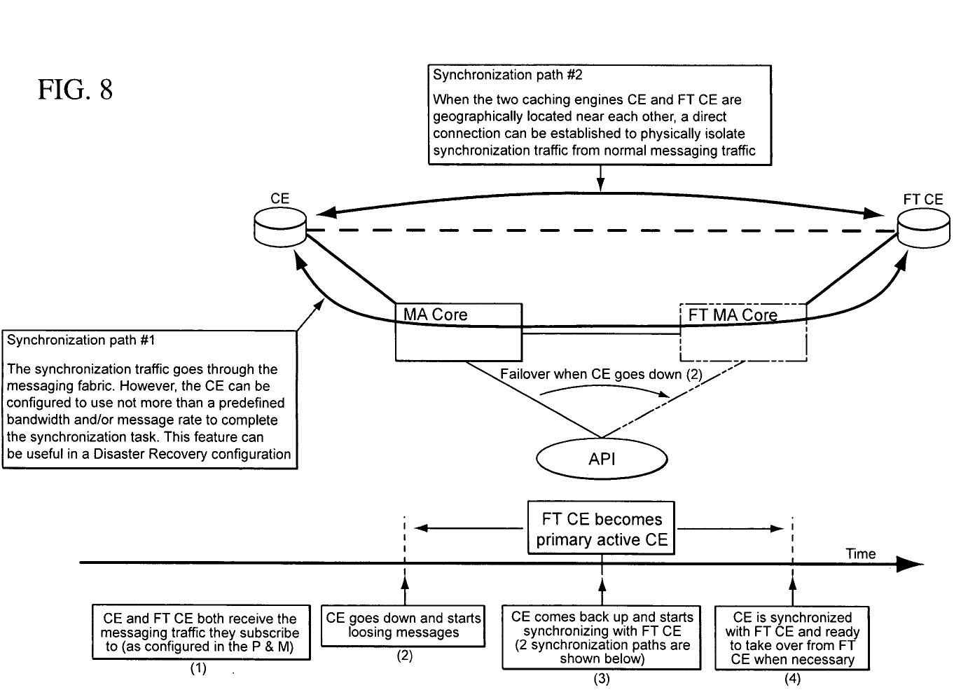

To further explain, FIG. 8 shows a messaging appliance with caching engine fault-tolerant pair configuration, and describes the failover process of the API from the primary MA to the secondary MA.

Before the CE failure event, i.e., at phase #1, the two caching engines both receive the same subscribed messaging traffic since they are both subscribing to the same topics. When the primary caching engine fails, event #2, the MA detects the failure, and fails over to the secondary MA (that take over for the primary MA), which in-turn makes the API fail over to the secondary MA as well. At some later time, the primary caching engine comes back up, event #3; it will re-initiate its subscriptions, and upon receipt of the data, it will detect the data loss on all of its subscriptions. This lost data will be requested by sending one or more replay requests per subscription to the secondary caching engine. The data synchronization phase will start between the primary and secondary caching engine, leveraging the messaging logic.

In one embodiment of the invention, the data synchronization traffic will go through the messaging fabric, as described on FIG. 8, synchronization path #1. This path might be configured to not exceed a pre-defined message rate or pre-defined bandwidth. This can be critical for a disaster recovery configuration, where the primary and secondary caching engines are located in different geographical locations, using a reduced-bandwidth inter-site link, such as a WAN link or a dedicated fiber connection.

Alternatively, in another embodiment of the invention, the data synchronization traffic will go through an alternative high-speed interconnect direct link or switch, such as Infiniband or Myrinet, to isolate the synchronization traffic from the regular messaging traffic. Such an alternative synchronization path #2 might be available as a primary or backup link for synchronization traffic. This link can be statically configured as the dedicated synchronization path, or can be dynamically selected in real-time based on the overall messaging fabric load. Either the caching engine or the messaging appliance can make the decision to move the synchronization traffic away from the messaging fabric towards this alternative synchronization path.

When the synchronization is done, event #4, the primary CE is ready to take over. At that time, the primary MA can either become active, or remain inactive until a failure occurs on the secondary CE and/or MA.

In sum, the present invention provides a new approach to messaging and more specifically an end-to-end publish/subscribe middleware architecture with a fault-tolerant persistent caching capability that improves the effectiveness of messaging systems, simplifies the manageability of the caching solution and reduces the recovery latency for various levels of guaranteed delivery quality-of-service. Although the present invention has been described in considerable detail with reference to certain preferred versions thereof, other versions are possible. Therefore, the spirit and scope of the appended claims should not be limited to the description of the preferred versions contained herein.

What is claimed is:

1. A messaging system, comprising:
one or more applications;
a plurality of messaging appliances operative for receiving and routing messages including to and from such applications; and
a plurality of caching engines arranged in a fault tolerant configuration in which one or more caching engines are connected to each designated messaging appliance from among the plurality of messaging appliances and in which each of the plurality of caching engines correspondingly subscribes to a topic and is logically linked to any one of the designated messaging appliances which is connected to a caching engine that correspondingly subscribes to the same topic in order to provide redundancy such that all caching engines in a group of caching engines that subscribe to the same topic receive the same message data and maintain a consistent, synchronized view of all message traffic associated with such topic.

2. A messaging system as in claim 1, having a messaging fabric for routing the message traffic that includes the plurality of messaging appliances and being operative to provide the consistent, synchronized view via the message fabric or, if a direct connect between caching engines exists, via such direct connect, with real-time failover being decided by either a messaging appliance or a caching engine based on messaging fabric load.

3. A messaging system as in claim 2, wherein the direct connect includes a high-speed direct connection or a switch.

4. A messaging appliance as in claim 3, wherein the high-speed direct connection includes an Infiniband or Myrinet interconnect.

5. A messaging system as in claim 1, wherein, for maintaining the consistent synchronized view each caching engine is operative to use a predefined bandwidth and/or message rate to acquire the message data.

6. A messaging system as in claim 1, operative such that upon failure of one or more caching engines, any other caching engine connected to the same messaging appliance that remains active takes over for the failing caching engines and, if none are left that are active or upon any other failure involving that messaging appliance, another messaging appliance which is logically linked to the caching engines of the failing messaging appliance takes over for it, wherein any takeover is transparent to the one or more applications that is logically connected to a failed caching engine and/or messaging appliance.

7. A messaging system as in claim 6, further operative such that any failing caching engine that has recovered retrieves lost data by requesting another caching engine that remained active to send to it the lost data.

8. A messaging system as in claim 1, wherein each caching engine has:
a message layer operative for sending and receiving messages,
a caching layer having an indexing service operative for first indexing received messages and for maintaining an image of received partially-published messages,
a storage and a storage service operative for storing all or a subset of received messages in the storage,
one or more physical channel interfaces for transporting received and transmitted messages, and
a messaging transport layer with channel management for controlling transmission and reception of messages through each of the one or more physical channel interfaces.

9. A messaging system as in claim 8, wherein the storage in each caching engine is operative to allow stored received messages to remain temporarily available for retransmission upon request from such caching engine.

10. A messaging system as in claim 1, further comprising a messaging fabric and a provisioning and management system linked via messaging fabric to the messaging appliances and configured for exchanging administrative messages with each messaging appliance.

11. A messaging system as in claim 1, wherein each messaging appliance is further operative for executing the routing of messages by dynamically selecting a message transmission protocol and a message routing path.

12. A messaging system as in claim 1, wherein the messaging fabric includes interconnect that is a channel-based, fabric agnostic physical medium.

13. A messaging system as in claim 12, wherein the interconnect is configured as Ethernet, memory-based direct connect or Infiniband.

14. A messaging system as in claim 12, wherein the interconnect is as a direct 10 Gigabit Ethernet fiber interconnect or Myrinet interconnect operative for high throughput and low-latency.

15. A messaging system as in claim 1, wherein the messages are constructed with schema and payload which are separated from each other when messages enter the messaging system and which are combined when messages leave the messaging system.

16. A messaging system as in claim 10, wherein the messages and administrative messages have a topic-based format, each message having a header and a payload, the header including a topic field in addition to source and destination namespace identification fields.

17. A messaging system as in claim 1, wherein the messages include a subscription message with a topic field that has a variable-length string with any number of wild card characters for matching it with any topic substring provided that such topic and the subscription message have the same number of topic substrings.

18. A messaging system as in claim 1, wherein the caching engines is operative for providing quality of service functionality including message data store and forward functionality.

19. A messaging system as in claim 8, wherein the storage associated with each caching engine includes multiple storage devices operative for distributed message input/output.

20. A messaging system as in claim 8, wherein the message layer in each caching engine includes an administrative message layer operative for handling administrative messages.

21. A messaging system as in claim 8, wherein the message layer in each caching engine is operative for retrieving requested messages from the caching layer and for formatting received messages with a header field and a payload.

22. A messaging system as in claim 8, wherein the caching layer further includes a random access memory (RAM) and wherein the indexing service is further operative to maintain the image in the RAM.

23. A messaging system as in claim 8, wherein the image of each partially-published message received and maintained by the caching layer includes updates and old values untouched by the updates.

24. A messaging system as in claim 9, wherein the time during which the messages remain in the storage temporarily available for retransmission is predetermined.

25. A messaging system as in claim 8, wherein the storage is a redundant persistent memory device.

26. A messaging system as in claim 1, provided as a software-based or embedded-based configuration.

27. A messaging system as in claim 1, embodied in a software application running on top of an operating system.

28. A messaging system as in claim 1, wherein the consistent, synchronized view of messaging traffic enables the messaging system to provide messaging quality of service including one or a combination of partial publish, conflated, guaranteed-while connected and guaranteed-while disconnected.

29. A method for providing quality of service in a messaging system, comprising: providing
arranging a messaging fabric with a plurality of messaging appliances;
arranging the plurality of caching engines in a fault tolerant configuration in which one or more caching engines are connected to each designated messaging appliance from among the plurality of messaging appliances;
logically linking, by subscription to a topic, each of the plurality of caching engines to any one of the designated messaging appliances to which are connected one or more than one other caching engines that, commonly with such caching engine, are subscribed to the a similar topic in order to provide redundancy,
for each group of caching engines that subscribe to the same topic synchronizing all the caching engines in the such that all caching engines in the group receive the same message data and maintain a consistent, synchronized view of all message traffic associated with such topic, and wherein such synchronization enables providing messaging quality of service.

30. A method as in claim 29, wherein messaging quality of service includes partial publish, conflated, guaranteed-while-connected and guaranteed-while-disconnected messaging.

31. A method as in claim 29, further comprising, upon failure of one or more caching engines, taking over for the failing caching engines by any other caching engine connected to the same messaging appliance that remains active and, if none are left that are active or upon any other failure involving that messaging appliance, taking over for the failing messaging appliance by another messaging appliance which is logically linked to the caching engines of the failing messaging appliance.

32. A method as in claim 29, further comprising interfacing between each of the caching engines and one or more applications via their respective designated messaging appliances, wherein any takeover is transparent to the one or more applications that is logically connected to a failed caching engine and/or messaging appliance.

33. A method as in claim 29, wherein maintaining the consistent, synchronized view is accomplished via the message fabric or, if a direct connect between caching engines exists, via such direct connect, with real-time failover being decided by either a messaging appliance or a caching engine based on messaging fabric load.

34. A method for providing quality of service with a caching engine, comprising:
in a caching engine having a messaging transport layer, an administrative message layer and a caching layer with an indexing service and an associated storage, performing the steps of:
receiving data and administrative messages by the message transport layer;
forwarding the administrative messages to the administrative message layer and the data messages to the caching layer, wherein message retrieve request messages forwarded to the administrative message layer are routed to the caching layer;
ndexing the data messages in the indexing service, the indexing being topic-based; and
storing the data messages in a storage device based on the indexing, wherein the data messages are maintained in the storage device for a predetermined period of time during which they are available for retransmission in response to message retrieve request messages.

35. A method for providing quality of service with a caching engine as in claim 34, wherein the data messages are either complete data messages or partially-published data messages.

36. A method for providing quality of service with a caching engine as in claim 35, wherein each data message has an associated topic, wherein the indexing service maintains a master image of each complete data message and, for a received data message that is a partially complete message, the indexing service compares the received data message against a most recent master image of a complete message with an associated topic similar to that of the partially-published message to determine how the master image should be updated.

37. A method for providing quality of service with a caching engine as in claim 35, wherein the partially-published message is indexed and available for retransmission.

38. A method for providing quality of service with a caching engine as in claim 36, wherein the master image is indexed and available for retransmission.

39. A caching engine in a messaging system, comprising:
a message layer operative for sending and receiving messages;
a caching layer having an indexing service operative for first indexing received messages and for maintaining an image of received partially-published messages, a storage and a storage service operative for storing all or a subset of received messages in the storage where they remain temporarily available for retransmission upon request;
one or more physical channel interfaces for transporting received and transmitted messages; and
a messaging transport layer with channel management for controlling transmission and reception of messages through each of the one or more physical channel interfaces.

40. A caching engine as in claim 41, deployed with a fault tolerant capability as part of a fault tolerant caching engines pair or a fault tolerant caching engines group where upon failure a secondary caching engine takes over for a primary caching engine.

41. A caching engine as in claim 42, wherein the message layer includes an administrative message layer operative for handling administrative messages.

42. A caching engine as in claim 39, wherein the message layer is operative for retrieving requested messages from the caching layer and for formatting received messages with a header field and a payload.

43. A caching engine as in claim 39, wherein the caching layer further includes a random access memory (RAM) and wherein the indexing service is further operative to maintain the image in the RAM.

44. A caching engine as in claim 39, wherein the image of each partially-published message received and maintained by the caching layer includes updates and old values untouched by the updates.

45. A caching engine as in claim 39, wherein the time during which the messages remain in the storage temporarily available for retransmission is predetermined.

46. A caching engine as in claim 39, wherein the storage is a redundant persistent memory device.

47. A caching engine as in claim 39, provided as a software-based or embedded-based configuration.

48. A caching engine as in claim 39, embodied in a software application running on top of an operating system.

49. A caching engine as in claim 39, operative for providing partial data publication service and guaranteed-connected and guaranteed-disconnected message delivery quality of service.

50. A caching engine as in claim 39, wherein the storage includes multiple storage devices operative for distributed message input/output.

51. A messaging system as in claim 1, further comprising a provisioning and management system operative for managing operations of the caching engines.

52. A messaging system as in claim 1, further comprising one or more application programming interfaces operative to allow the applications to publish and subscribe in native message format.

53. A messaging system as in claim 1, further comprising one or more protocol translation engines associated with any one of the messaging appliances and operative to allow the applications to publish and subscribe in external message format.
